(19) United States
(12) Patent Application Publication
(10) Pub. No.: US 2013/0024015 A1
(43) Pub. Date: Jan. 24, 2013

(54) METHOD FOR CONTROLLING BUILDING AUTOMATIC CONTROLL DEVICE

(71) Applicants: Byung Hoon YOO, Anyang-si (KR); Kyung Jae Lee, Seoul (KR)

(72) Inventors: Byung Hoon YOO, Anyang-si (KR); Kyung Jae Lee, Seoul (KR)

(21) Appl. No.: 13/363,525

(22) Filed: Feb. 1, 2012

(30) Foreign Application Priority Data
Jul. 21, 2011 (KR) 10-2011-0072422

(51) Int. Cl. G06F 19/00

(52) U.S. Cl. 700/54

(57) ABSTRACT

The present disclose a method for controlling a building automatic control device comprising a CPU module including a main-CPU module and a sub-CPU module, a functional module and a host. The method comprises an initial operation step, a synchronization step, a conversion step, a restoring step and a reporting step. By the method, the CPU module which is duplicated to gain safety of a direction digital control (DDC) used in the building automatic control device operate continuously.

### FIELD

The present invention may relate to a method for controlling a building automatic control device, more particularly, to a method for controlling a building automatic control device to continuously operate a central processing unit (CPU) that is duplicated to gain safety of a direction digital control (DDC) used in the building automatic control device.

### BACKGROUND

Generally, a building automatic control device is a system capable of controlling equipments used in heating/cooling, lighting, security for a large building by using a central computer of a central control center.

In a conventional building automatic control device, direct digital control (DDC) is used to control the equipments. Under the direct digital control, a host, a central processing unit (CPU) module and a functional module may transmit and receive information in communication with each other.

In reference to FIG. 1, the conventional building automatic control device includes a host 10, a main-CPU module 12a, a sub-CPU module 12b and functional modules 14a, 14b, 14c and 14d.

The host 10 is connected to the main-CPU module 12a and the sub-CPU module 12b via a first bus line (L1). The main-CPU module 12a and the sub-CPU module 12b are connected to the functional modules 14a, 14b, 14c and 14d via a second bus line (L2).

The first bus line (L1) is configured of a network cable (RS485) for building automatic control network and the second bus line (L2) is configured of a serial communication cable for serial communication.

In this instance, when the main-CPU module 12a is shut down, the equipments are controlled according to the operation of the sub-CPU module 12b. If the main-CPU module 12a is restored to a normal state, the control is handed over to the main-CPU module 12a from the sub-CPU module 12b and the main-CPU module 12a starts to control the equipments.

However, the conventional building automatic control device detects periodic communication between the main-CPU module 12a and the functional modules 14a, 14b, 14c and 14d and it determines whether the control function of the main-CPU module 12a is handed over. Accordingly, there might be a time space until the sub-CPU module 12b starts to operate after given the function of the main-CPU 12a.

Also, when the sub-CPU module 12b controls the equipments after given the control from the main-CPU module 12a, there might be loss of communication information transmitted between the main-CPU module 12a and the host 10 and between the main-CPU module 12a and the functional modules 14a, 14b, 14c and 14d. For example, data for input and output, time data, variable data and other data might be lost. As a result, serial operation between the main-CPU Module 12a and the sub-CPU module 12b might be lost disadvantageously.

### REFERENCED PRIOR ART

Abstract disclosed in Page 1, Line 9 to 20 of Page 3, Line 50 of Page 3 to Line 19 of Page 4 and FIGS. 2 and 3 in Korea Patent No. 2000-0056861.

### DETAILED DESCRIPTION OF THE INVENTION

### Technical Problem

An object of the present invention may be to provide a method for controlling a building automatic control device which can perform synchronization of duplicated CPU modules to enable the other one of CPU modules to be operated continuously when one of the CPU modules is shut down.

Another object of the present invention may be to provide a method for controlling a building automatic control device which can back up an initial state of an added CPU module rapidly, when a new CPU module is added, with a CPU module being in operation.

A further object of the embodiment of the invention is to provide a method for controlling a building automatic control device which can transmit operation states of a main-CPU module and a sub-CPU module to a host rapidly.

### Technical Solution

To achieve these objects and other advantages and in accordance with the purpose of the embodiments, as embodied and broadly described herein, a method for controlling a building automatic control device comprising a CPU module including a main-CPU module and a sub-CPU module, a functional module and a host, the method includes an initial operation step of performing an initial operation for the main-CPU module and the sub-CPU module; a synchronization step of synchronizing the main-CPU module and the sub-CPU module after the initial operation step; a conversion step of enabling the other one of the main-CPU module and the sub-CPU module in a standby state for communication with the host to continuously perform the operation performed by one of the main-CPU module and the sub-CPU module transmitting/receiving communication information in communication with the functional module and the host, in communication with the functional module and the host, when one of the main-CPU module and the sub-CPU module is in a down state in which communication is shut down; a restoring step of restoring the CPU module in the down state out of the main-CPU module and the sub-CPU module; and a reporting step of the host being reported by the CPU module in communication with the host out of the main-CPU module and the sub-CPU that the operation states of the main-CPU module and the sub-CPU module are converted, the reporting step performed simultaneously with the conversion step or the restoring step..

The synchronization step may include an initial backup step of enabling the other one of the main-CPU module and the sub-CPU module to transmit initial backup information to one of the main-CPU module and the sub-CPU module, in communication with the other CPU module, when one of the main-CPU module and the sub-CPU module is restored to be in the standby state from the down state; and a synchronization maintaining step of maintaining the standby state of the one of the main-CPU module and the sub-CPU module continuously while the one of the main-CPU module and the sub-CPU module receives the communication information from the functional module.

The method according to the invention may further include a displaying step of displaying conversion of the operation state to a user, in communication with the CPU module transmitting/receiving the communication information in communication with the functional module and the host out of the main-CPU module and the sub-CPU module, the displaying step performed simultaneously with the reporting step.

In the initial operation step, the main-CPU module may be operated in a ready state where preparation for communication with the host and the functional module is ready and the sub-CPU module may be operated in the standby state.

The main-CPU module and the sub-CPU module restored from the down state in the restoring step may be set to be in the standby state.

The operation states of the main-CPU module and the sub-CPU module may be displayed as a first flag representing which one of the main-CPU module and the sub-CPU module is in communication with the host and a second flag representing whether there is the CPU module in the standby state out of the main-CPU module and the sub-CPU module.

### Advantageous Effects

The embodiments have following advantageous effects.

First, the CPU module in operation and the CPU module in standby are synchronized. Even when the CPU module in operation is shut down, the CPU module in standby can be operated based on the synchronized communication information. Accordingly, there is an effect of the CPU module in standby performing the control operation of the CPU in operation continuously.

Second, a new CPU module in a standby state is added while one CPU module is in communication. Simultaneously, the CPU module may transmit initial backup information to the other added CPU module at a time and an initial state of the added CPU module may back up. Accordingly, there may be an effect of reducing data loss and of performing an initial setting of the added CPU module added in the standby state rapidly at the same time.

Lastly, only when the operation state of the CPU module is converted in communication with the host, the converted operation state may be reported to the host. Accordingly, there may be an effect of reducing communication data load and of enabling the host to receive the operation state of the CPU rapidly.

### BRIEF DESCRIPTION OF THE DRAWINGS

FIG. 1 is a block view of a conventional building automatic control device according to a conventional technology;

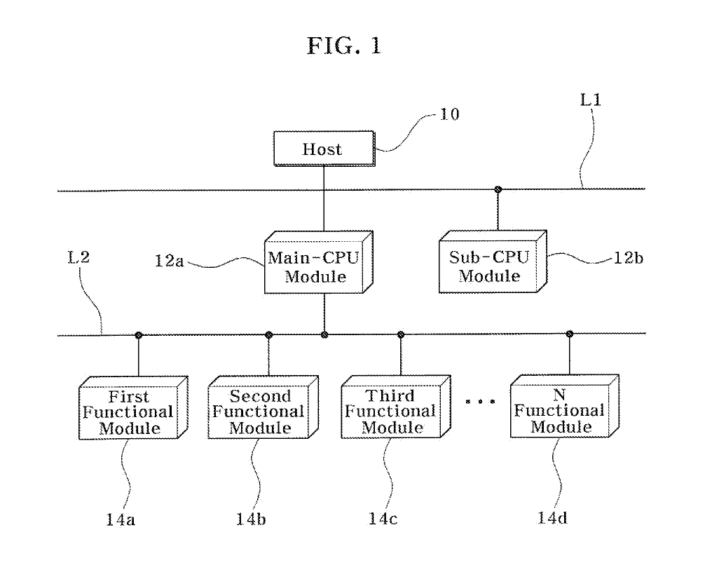

FIG. 2 is a block view of a building automatic control device according to an embodiment of the invention;

FIG. 3 is a flow chart illustrating a method for controlling the building automatic control device according to an embodiment of the invention; and

FIG. 4 is a table showing an operation state of a CPU module provided in the building automatic control device according to the embodiment of the invention.

### BEST MODE

As follows, a method for controlling a building automatic control device according to an embodiment of the invention will be described in reference to the accompanying drawings.

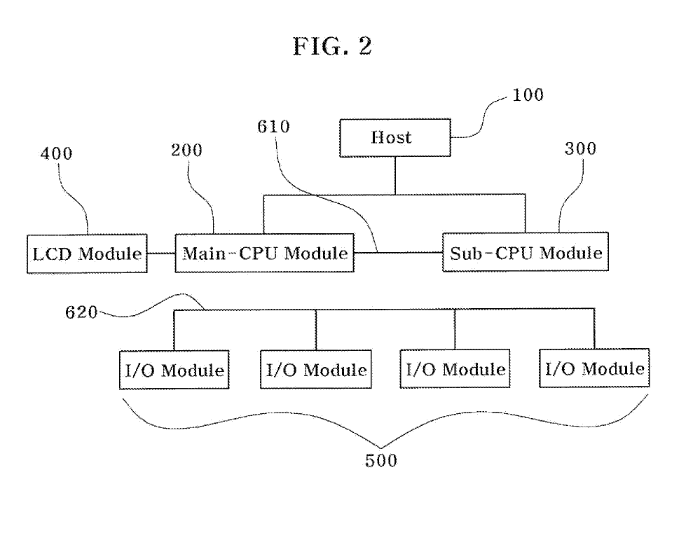

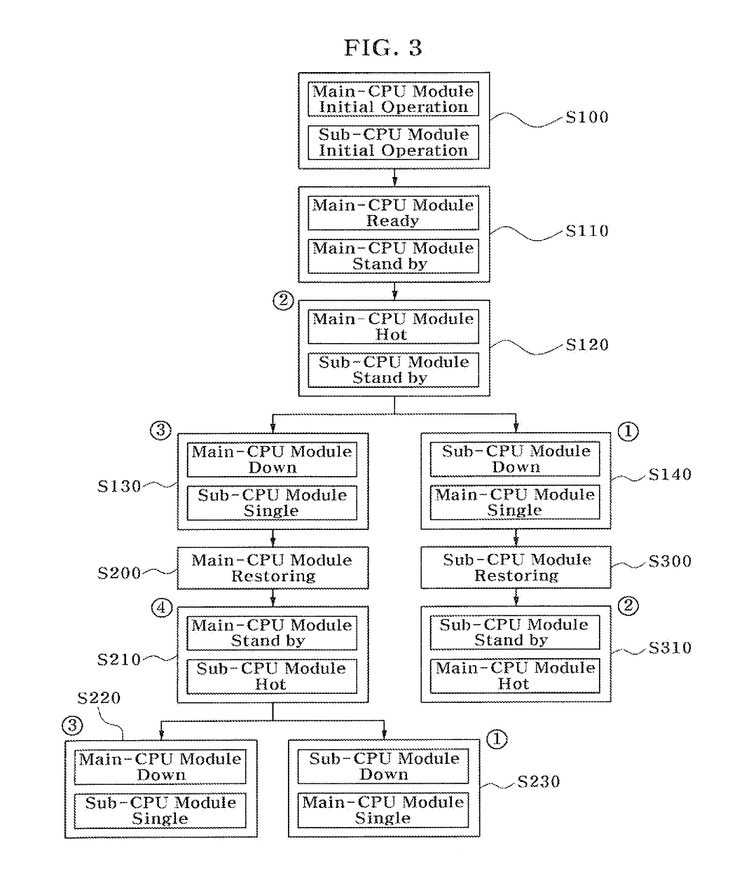

In reference to FIGS. 2 to 4, a building automatic control device may include a host 100, a CPU module having a main-CPU module 200 and a sub-CPU module 300, a liquid crystal display (LCD) module 400 and a functional module 500.

The main-CPU module 200 and the sub-CPU module 300 may be connected to the host 100 via a first bus line 610. In this instance, the first bus line 610 may be used for RS485 communication or Ethernet.

Also, the main-CPU module 200, the sub-CPU module 300 and the functional module 500 may be connected to each other via a second bus line 620. In this instance, the second bus line 620 may be used for serial communication.

Also, the main-CPU module 200 and the sub-CPU module 300 may be connected to the LCD module 400 via the second bus line 620.

The functional module 500 may include a plurality of I/O modules. The I/O modules may be employed to help the main-CPU module 200 and the sub-CPU module 300 to control equipments connected with the CPU module.

Specifically, the I/O modules may process a data format and electrical details of the equipments to enable the main-CPU module 200 and the sub-CPU module 300 to control the equipments by using simple instructions.

The LCD module 400 may communicate with one of the CPU modules in operation and it may display operation states of the main-CPU module 200 and the sub-CPU module 300.

The LCD module 400 may include a panel (not shown) to display the operation state of the CPU module and a controller (not shown) to operate the LCD module 400.

Meanwhile, the main-CPU module 200 and the sub-CPU module 300 may communicate with the host 100, only in operation.

In this instance, the operation states of the main-CPU module 200 and the sub-CPU module 300 may be defined as follows.

When the communication with the host 100 and the functional module 500 is shut down, the main-CPU module 200 may be in a down state.

Also, when the main-CPU module 200 is on standby to communicate with the host 100, the main-CPU module 200 may be in a standby state. In other words, the main-CPU module 200 may not communicate with the host 100 in the standby state but with the functional module 500.

When the sub-CPU module 300 is in a down state, with the main-CPU module 200 being communicating with the host 100 and the functional module 500, the main-CPU module 200 may be a single state.

Also, when the sub-CPU module 300 is in the standby state, with the main-CPU module 200 communicating with the host 100 and the functional module 500, the main-CPU module 200 may be in a hot state.

Like the main-CPU module 200, the sub-CPU module 300 may have the down state, the standby state, the single state and the hot state.

When starting an initial operation, the main-CPU module 200 may be in a ready state where preparation for communication with the host 100 and the functional module 500 is ready completely. However, when starting an initial operation, the sub-CPU module 300 maybe in the standby state.

Meanwhile, when the sub-CPU module 300 is restored from the down state, with the main-CPU module 200 being in operation, the sub-CPU module 300 may be set to be in the standby state.

Similarly, when the main-CPU module 200 is restored from the down state, with the sub-CPU module 300 being in operation, the main-CPU 200 may be set to be in the standby state.

Meanwhile, a master mode may be set in which the main-CPU 200 is in the hot state or the single state and a slave mode may be set in which the sub-CPU module 300 is in the hot state or the single state.

A normal mode may be set in which a specific CPU module is used constantly, without duplicating the CPU module into the main-CPU module 200 and the sub-CPU module 300.

The LCD module 400 may display whether the CPU module operating currently is in the master mode or the slave mode, to enable a user to identify the state of the CPU module outside, and it may display whether the CPU module is in the hot state or the single state in the master mode or whether the CPU module is in the hot state or the single state in the slave mode.

As a result, the user may identify which state the currently operating CPU module is in.

In reference to FIGS. 2 to 4, a method for controlling a building automatic control device according to the invention will be described in detail as follows.

First of all, an initial operation step may be performed in which a main-CPU module 200 and a sub-CPU module 300 are operated in an initial stage (S100).

When the initial stage is performed to the set main-CPU module 200 and the sub-CPU module 300 set by an electric power applied to them simultaneously, a ready state may be set to the main-CPU module 200 and a ready state may be set to the sub-CPU module 300 (S110).

In this instance, a time difference of operating points may be preset to operate the main-CPU module 200 prior to the sub-CPU module 300, even when the electric power is simultaneously applied to the set main-CPU module 200 and the set sub-CPU module 300.

Hence, the main-CPU module 200 may check the state of the sub-CPU module 300. Specifically, the main-CPU module 200 may determine whether the sub-CPU module 300 is in communication with the host 100 and the functional module 500 via the first bus line 610 and the second bus line 620.

When the sub-CPU module 300 is in communication only with the function module 500, not with the host 100, that is, in the standby state, the hot state may be set to the main-CPU module 200 (S120).

If the communication between the sub-CPU module 300 and the host 100 and the functional module 500 is shut down, that is, in a down state, even after the electric power is applied to the sub-CPU module 300, a single stage may be set to the main-CPU module 200.

Meanwhile, when the main-CPU module 200 is in the hot state and the sub-CPU module 300 is in the standby state (hereinafter, in a second state), data between the main-CPU module 200 and the sub-CPU module 300 may be synchronized.

Specifically, the main-CPU module 200 outputs required data to the functional module 500, with polling the functional module 500. After that, the functional module 500 may report response data to the main-CPU module 200.

In this instance, the sub-CPU module 300 may receive communication information having the response data from the functional module 500 and synchronization may be performed between the sub-CPU module 300 and the main-CPU module 200. In other words, a synchronization maintaining step may be performed in which the sub-CPU module 300 receives the communication information from the functional module 500, with maintaining the standby state constantly.

For example, data related to control/monitoring instruction may be transmitted to the main-CPU module and the sub-CPU module from the functional module 500 simultaneously.

At the same time, the main-CPU module may communicate with the host 100 constantly, with monitoring the state of the sub-CPU module.

As a result, the main-CPU module 200 and the sub-CPU module 300 may have the communication information including the same control/monitoring data.

Meanwhile, when the main-CPU module 200 in the second state is converted in the down state from the hot state, the sub-CPU module 300 may be set to be in the single state from the standby state (S130) (hereinafter, ‘a third state).

In other words, a conversion step may be performed in which the sub-CPU module 300 performs the operation performed by the main-CPU module 200 and the communication with the host 100 and the functional module 500 simultaneously, with the standby of the sub-CPU module 300 being converted into the single state.

In this instance, even when the main-CPU module 200 is in the down state, the sub-CPU module 300 already has the data synchronized with the main-CPU module 200 and it can continuously perform the function performed by the main-CPU module 200. Accordingly, the control for the building automatic control device may be performed stably.

At the same time, when the operation state of the CPU module is converted into the third state from the second state, the sub-CPU module 300 may report the conversion of the operation state to the host 100.

In other words, the sub-CPU module 300 may report to the host 100 that the current state of the CPU module is the single state in the slave mode.

Also, the Led module 400 in communication with the sub-CPU module 300 may display the operation state of the CPU module.

As a result, only when there is change in the operation state of the CPU module, the currently operating CPU module reports the converted operation state to the host 100 and the communication data may be reduced. Accordingly, conversion on the operation state of the CPU module can be identified rapidly.

Meanwhile, the sub-CPU module 300 in the second state is converted to be in the down state from the standby state, the main-CPU module 200 may be set to be in the single state from the hot state (S140) (hereinafter, ‘a first state).

In this instance, when the operation state of the CPU module is converted from the second state to the first state, the main-CPU module 200 may report to the host 100 that the operation state of the main-CPU module 200 is the single state in the master mode.

Similarly, the LED module 400 in communication with the main-CPU module 200 may display the operation sate of the CPU module.

Meanwhile, when the main-CPU module 200 in the down state in the third state is restored (S220), the main-CPU module 200 may be set to be in the standby state and the sub-CPU module 300 may be set to be in the hot state from the single state simultaneously (S210) (hereinafter, ‘a fourth state’).

In this instance, an initial back-up step may be performed in which the sub-CPU module 300 transmit initial back-up information related to the monitoring/control data, time, variables, input/output values and timer possessed by the sub-CPU module 300 to the main-CPU module 200, while communicating with the main-CPU module 200, to back-up the main-CPU module at a time.

Specifically, when the main-CPU module 200 is restored to be in the standby state, the sub-CPU module 300 may communicate with the main-CPU module 200 for data transmission of data performed initial at a time. After that, the main-CPU module 200 may be synchronized with the sub-CPU module 300 in the synchronization maintaining step by communication with the functional module 500 and the main-CPU module may check the state of the sub-CPU module constantly.

As a result, when a new CPU module is added, with the operating CPU module data backup for the added CPU module may be performed rapidly and data loss generated in the added CPU module can be prevented.

At the same time, when the operation state of the CPU module is converted from the third state to the fourth state, the sub-CPU module 300 may report to the host 100 that the current operation state of the CPU module is the hot state in the slave mode.

Similarly, the LED module 400 in communication with the sub-CPU module 300 may display the operation state of the CPU module.

Meanwhile, when the main-CPU module in the fourth state is converted to be in the down state, the sub-CPU module 300 in the fourth state may be converted to be in the single state, that is, the first state from the hot state (S220).

Also, when the sub-CPU module 300 in the fourth state is converted to be in the down state, the main-CPU module 200 in the fourth state may be converted to be the single state, that is, the third state from the standby state (S230).

Meanwhile, when the sub-CPU module 300 in the down state in the first state is restored (S300), the sub-CPU module 300 may be set to be in the standby state and the main-CPU module may be set to be in the hot state from the single state. In other words, when the sub-CPU module 300 in the first state is restored, the sub.-CPU module 300 in the first state may be converted to be in the second state (S310).

In this instance, the main-CPU module 200 may transmit initial backup information related to the monitoring/control data, the time, the variables, the input/output values and the timer to the sub-CPU module 300, while communicating with the sub-CPU module 300, to backup the sub-CPU module 300 at a time.

Also, when the operation state of the CPU module is converted from the first state to the second state, the main-CPU module 200 reports to the host 100 that the current operation state of the CPU module is the hot state in the master mode.

Similarly, the LED module 400 in communication with the main-CPU module 200 may display the operation state of the CPU module.

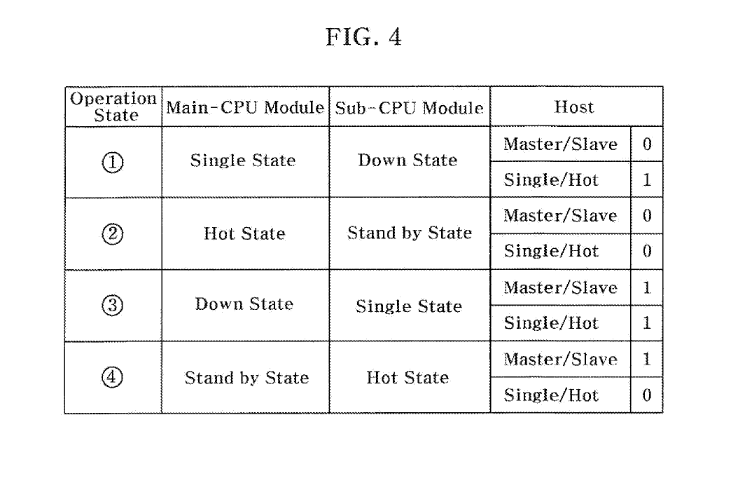

In this instance, the operation state of the CPU module may be displayed by a first flag and a second flag. The first flag displays which one of the main-CPU module and the sub-CPU module is in communication with the host 100. The second flag displays whether there is the CPU module in the standby state out of the main-CPU module and the sub-CPU module. The operation state of the CPU module will be described later in reference to FIG. 4.

Meanwhile, a method for displaying the operation state of the CPU module to the LCD module may be realized in various ways. For example, the operation state of the CPU module may be displayed to the LCD panel (not shown) in letters or sounds and the embodiment of the invention is not limited thereto. The operation state of the CPU module may be realized by a light emitting diode (LED) emitting different lights.

In reference to FIG. 4, the operation states reported to the host 100 and displayed to the LCD module 400 will be described as follows.

First of all, when the main-CPU module 200 is in the single state and the sub-CPU module 300 is in the down state (\textcircled{1}), that is, the first state, the host 100 may be reported by the main-CPU module 200 that the current operation state of the CPU module is the single state in the master mode and the LCD module 400 may display that the operation state of the CPU module is the single state in the master mode.

Specifically, the first flag displaying the master mode and the slave mode may have a value of ‘0’ and the second flag displaying the single state and the hot state may have a value of ‘1’.

In this instance, the first flag may represent whether the currently operating CPU module is the main-CPU module 200 or the sub-CPU module. The second flag may represent whether there is the CPU module in the standby state out of the main-CPU module and the sub-CPU module.

Also, when the main-CPU module 200 is in the hot state and the sub-CPU module 300 is in the standby state (\textcircled{2}), that is, the second state, the host 100 may be reported by the main-CPU module 200 that the current operation state of the CPU module is the single state in the master mode and the LCD module 400 may display that the operation state of the CPU module is the hot state in the mater mode. In other words, the first flag may have a value of ‘0’ and the second flag may have a value of ‘0’.

Also, when the main-CPU module 200 is in the down state and the sub-CPU module 300 is in the single state (\textcircled{3}), that is, the third state, the host 100 may be reported by the sub-CPU module 300 that the current operation state of the CPU module is the single state in the slave mode and the LCD module 400 may display that the operation state of the CPU module is the single state in the slave mode. In other words, the first flag may have a value of ‘1’ and the second flag may have a value of ‘1’.

When the main-CPU module 200 is in the standby state and the sub-CPU module 300 is in the hot state (\textcircled{4}), that is, the fourth state, the host may be reported by the sub-CPU module 300 that the current operation state of the CPU module is the hot state in the slave mode and the LCD module 400 may display that the operation state of the CPU module is the hot state in the slave mode. In other words, the first flag may have a value of ‘1’ and the second flag may have a value of ‘0’.

The embodiment of the invention is not limited thereto and the LCD module 400 may display the operation states of the main-CPU module 200 and the sub-CPU module 300 independently.

For example, when the main-CPU module 200 is in the single state, a first LED is luminous. When the main-CPU module 200 is in the hot state, a second LED is luminous. In case of the down state, a third LED is luminous and in case of the standby state, a fourth LED is luminous. In this instance, the operation state of the sub-CPU module 300 may be represented like the operation state of the main-CPU module 200.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling a building automatic control device comprising a CPU module including a main-CPU module and a sub-CPU module, a functional module and a host, the method comprising:
an initial operation step of performing an initial operation for the main-CPU module and the sub-CPU module;
a synchronization step of synchronizing the main-CPU module and the sub-CPU module after the initial operation step;
a conversion step of enabling the other one of the main-CPU module and the sub-CPU module in a standby state for communication with the host to continuously perform the operation performed by one of the main-CPU module and the sub-CPU module transmitting/receiving communication information in communication with the functional module and the host, in communication with the functional module and the host, when one of the main-CPU module and the sub-CPU module is in a down state in which communication is shut down;
a restoring step of restoring the CPU module in the down state out of the main-CPU module and the sub-CPU module; and
a reporting step of the host being reported by the CPU module in communication with the host out of the main-CPU module and the sub-CPU that the operation states of the main-CPU module and the sub-CPU module are converted, the reporting step performed simultaneously with the conversion step or the restoring step.

2. The method according to claim 1, wherein the synchronization step comprises,
an initial backup step of enabling the other one of the main-CPU module and the sub-CPU module to transmit initial backup information to one of the main-CPU module and the sub-CPU module, in communication with the other CPU module, when one of the main-CPU module and the sub-CPU module is restored to be in the standby state from the down state; and
a synchronization maintaining step of maintaining the standby state of the one of the main-CPU module and the sub-CPU module continuously while the one of the main-CPU module and the sub-CPU module receives the communication information from the functional module.

3. The method according to claim 1, further comprising:
a displaying step of enabling a LCD module to display conversion of the operation state to a user, in communication with the CPU module transmitting/receiving the communication information in communication with the functional module and the host out of the main-CPU module and the sub-CPU module, the displaying step performed simultaneously with the reporting step.

4. The method according to claim 2, further comprising:
a displaying step of displaying conversion of the operation state to a user, in communication with the CPU module transmitting/receiving the communication information in communication with the functional module and the host out of the main-CPU module and the sub-CPU module, the displaying step performed simultaneously with the reporting step.

5. The method according to claim 1, wherein in the initial operation step, the main-CPU module is operated in a ready state where preparation for communication with the host and the functional module is ready and the sub-CPU module is operated in the standby state.

6. The method according to claim 2, wherein in the initial operation step, the main-CPU module is operated in a ready state where preparation for communication with the host and the functional module is ready and the sub-CPU module is operated in the standby state.

7. The method according to claim 1, wherein the main-CPU module and the sub-CPU module restored from the down state in the restoring step are set to be in the standby state.

8. The method according to claim 2, wherein the main-CPU module and the sub-CPU module restored from the down state in the restoring step are set to be in the standby state.

9. The method according to claim 1, wherein the operation states of the main-CPU module and the sub-CPU module are displayed as a first flag representing which one of the main-CPU module and the sub-CPU module is in communication with the host and a second flag representing whether there is the CPU module in the standby state out of the main-CPU module and the sub-CPU module.

10. The method according to claim 2, wherein the operation states of the main-CPU module and the sub-CPU module are displayed as a first flag representing which one of the main-CPU module and the sub-CPU module is in communication with the host and a second flag representing whether there is the CPU module in the standby state out of the main-CPU module and the sub-CPU module.
